(19) United States
(12) Patent Application Publication
(10) Pub. No.: US 2025/0223189 A1
(43) Pub. Date: Jul. 10, 2025

(54) POSITIVE ELECTRODE ACTIVE MATERIAL WITH CONTROLLED SPECIFIC SURFACE AREA, METHOD OF PREPARING SAME, AND POSITIVE ELECTRODE CONTAINING SAME

(71) Applicants: Hyundai Motor Company, Seoul (KR); Kia Corporation, Seoul (KR)

(72) Inventors: Sung Woo Noh, Seoul (KR); Hong Seok Min, Yongin-si (KR); Je Sik Park, Seoul (KR); Jeong Hyun Seo, Daejeon (KR); Chung Bum Lim, Suwon-si (KR); Yong Seok Lee, Suwon-si (KR); Joo Young Lee, Pyeongtaek-si (KR); Ju Yeong Seong, Seongnam-si (KR); Im Sul Seo, Cheongju-si (KR)

(21) Appl. No.: 18/806,315

(22) Filed: Aug. 15, 2024

(30) Foreign Application Priority Data
Jan. 8, 2024 (KR) 10-2024-0002831

(51) Int. Cl. C01G 53/00; H01M 10/0562

(52) U.S. Cl. CPC C01G 53/50; H01M 10/0562; C01P 2006/12; C01P 2006/40; H01M 2300/0068

(57) ABSTRACT

A positive electrode active material with a controlled specific surface area, a method of preparing the same, and a positive electrode containing the same, can have a density of the positive electrode active material being optimized by controlling the sintering conditions and composition of the positive electrode active material, thus maximizing the output characteristics of an all-solid-state battery containing the same. The positive electrode active material can include a lithium composite oxide enabling intercalation or deintercalation of lithium, wherein in the lithium composite oxide, a ratio (Sₘ/S_{c}) of a measured specific surface area (Sₘ) based on a Brunauer-Emmett-Teller (BET) method to a calculated specific surface area (S_{c}) based on a particle size distribution (PSD) analysis result is in a first range of 2.0 to 3.3.

### CROSS-REFERENCE TO RELATED APPLICATIONS

The present application claims priority to Korean Patent Application No. 10-2024-0002831, filed Jan. 8, 2024, the entire contents of which is incorporated herein for all purposes by this reference.

### TECHNICAL FIELD

The present disclosure relates to a positive electrode active material.

### BACKGROUND

Batteries are configured to store power by using materials enabling electrochemical reactions in positive and negative electrodes. A representative example of such batteries is a lithium secondary battery that stores electrical energy by a difference in chemical potential when lithium ions are intercalated in or deintercalated from positive and negative electrodes. Lithium secondary batteries are used not only in small electronic devices, such as mobile phones and laptops, but also in large vehicles for transportation, such as hybrid vehicles and electric vehicles. Accordingly, there is a need to develop secondary batteries with higher stability and energy density.

Typically, such lithium secondary batteries are manufactured by filling between positive and negative electrodes with an organic electrolyte or polymer electrolyte with the use of materials enabling reversible intercalation or deintercalation of lithium ions as positive and negative electrode active materials. Most existing secondary batteries have organic liquid electrolyte-based cells and thus show limitations in improving stability and density.

All-solid-state batteries, which are attracting attention as next-generation secondary batteries to solve such problems, are composed of all solid components and thus are advantageous due to having less risk of fire and explosion compared to the lithium secondary batteries using flammable organic solvents as electrolytes, and higher mechanical strength. Such an all-solid-state battery typically includes a positive electrode active material layer bonded to a positive electrode current collector, a negative electrode active material layer bonded to a negative electrode current collector, and a solid electrolyte layer positioned between the positive and negative electrode active material layers.

However, to apply such all-solid-state batteries universally in technical fields, such as electric vehicles, that require high output, it is necessary to improve the output characteristics of a positive electrode containing a positive electrode active material.

### SUMMARY

The present disclosure relates to a positive electrode active material with a controlled specific surface area, a method of preparing the same, and a positive electrode containing the same. Specifically, the density of the positive electrode active material can be optimized by controlling the sintering conditions and composition of the positive electrode active material, thus maximizing the output characteristics of an all-solid-state battery containing the same.

Some embodiments of the present disclosure can solve the problems described above, to obtain the optimal density of a positive electrode active material, thereby maximizing the output characteristics of a positive electrode containing the same. Some embodiments of the present disclosure can provide the optimal density of the positive electrode active material by controlling the sintering conditions and composition of the positive electrode active material.

Advantages of the present disclosure are not limited to the advantages mentioned herein. The above and other advantages of the present disclosure can be understood from the following description and in accordance with the appended claims, and combinations thereof.

One embodiment of the present disclosure can provide a positive electrode active material for an all-solid-state battery, the active material including a lithium composite oxide enabling intercalation or deintercalation of lithium, where in the lithium composite oxide, a ratio (Sₘ/S_{c}) of a measured specific surface area (Sₘ) based on a Brunauer-Emmett-Teller (BET) method to a calculated specific surface area (S_{c}) based on a particle size distribution (PSD) analysis result is in a range of 2.0 to 3.3.

In one example, the calculated specific surface area (S_{c}) may satisfy the following equation:

$$Sc ( {m}^{2} / g ) = \frac{{\sum }_{d = 1}^{∞} ( {( ( {Size}_{d} ) \frac{1}{2} )}^{2} \times \% {Chan}_{d} ) \times 4}{{\sum }_{d = 1}^{∞} ( \frac{4}{3} {( ( {Size}_{d} ) \frac{1}{2} )}^{3} \times \% {Chan}_{d} ) \times 4.77}$$

(Here, d represents any positive electrode active material, Size_{d} is a particle diameter of positive electrode active material d, and % Chan_{d} is a ratio of the positive electrode active material having particle diameter Size_{d} to the entire positive electrode active material expressed in %.).

In one example, the lithium composite oxide may be represented by Formula 1.

LiNi_{1-x-y}CoₓMn_{y}M¹_{z}O₂ [Formula 1]

(Here, x, y, and z may satisfy 0<x<0.4, 0<y<0.4, 0≤z<0.4, and 0<x+y+z≤0.4, and M¹ may include at least one element selected from the group consisting of Ti, Zr, Nb, W, P, Al, Mg, V, Ca, Sr, and Cr.)

In one example, the ratio (Sₘ/S_{c}) of the measured specific surface area (Sₘ), based on the Brunauer-Emmett-Teller (BET) method, to the calculated specific surface area (S_{c}), based on the particle size distribution (PSD) analysis result, may be in a range of 2.59 to 3.05.

In one embodiment, a positive electrode active material layer for an all-solid-state battery, which can include the positive electrode active material and a sulfide-based solid electrolyte, is provided.

In one example, the sulfide-based solid electrolyte may be represented by Formula 2.

Li_{3-2X}M²_{X}In_{1-Y}M³_{Y}L_{6-Z}L′_{Z} [Formula 2]

(Here, M² and M³ are each independently one selected from the group consisting of S, Sn, Mg, Ba, B, Al, Ga, In, Si, Ge, Pb, N, P, As, Sb, Bi, Ti, V, Cr, Mn, Fe, Co, Ni, Cu, Y, Zr, Nb, Mo, Tc, Ru, Rh, Pd, Ag, Hf, Ta, W, La, and a combination thereof, L and L′ are each independently one selected from the group consisting of Cl, Br, I, and a combination thereof, X, Y, and Z satisfy 0≤X<1.5, 0≤Y<1, and 0≤Z≤6, respectively.)

An embodiment of the present disclosure can provide a method of preparing a positive electrode active material for an all-solid-state battery, which can include: synthesizing a hydroxide precursor containing a transition metal; and obtaining a lithium composite oxide by mixing a lithium precursor with the hydroxide precursor and then subjecting the resulting mixture to heat treatment, in which the heat treatment is performed at a temperature of higher than 700° C. and lower than 800° C.

In one example, in the lithium composite oxide prepared according to the preparation method embodiment, a ratio (Sₘ/S_{c}) of a measured specific surface area (Sₘ) based on a BET method to a calculated specific surface area (S_{c}) based on a particle size distribution (PSD) analysis result may be in a range of 1.5 to 2.5.

In one example, the calculated specific surface area (S_{c}) may satisfy the following equation:

$$Sc ( {m}^{2} / g ) = \frac{{\sum }_{d = 1}^{∞} ( {( ( {Size}_{d} ) \frac{1}{2} )}^{2} \times \% {Chan}_{d} ) \times 4}{{\sum }_{d = 1}^{∞} ( \frac{4}{3} {( ( {Size}_{d} ) \frac{1}{2} )}^{3} \times \% {Chan}_{d} ) \times 4.77}$$

(Here, d represents any positive electrode active material, Size_{d} is a particle diameter of positive electrode active material d, and % Chan_{d} is a ratio of the positive electrode active material having particle diameter Size_{d} to the entire positive electrode active material expressed in %.).

In one example, the lithium composite oxide, prepared according to the preparation method embodiment, may be represented by Formula 1.

LiNi_{1-x-y}CoₓMn_{y}M¹_{z}O₂ [Formula 1]

(Here, x, y, and z may satisfy 0<x<0.4, 0<y<0.4, 0≤z<0.4, and 0<x+y+z≤0.4, and M¹ may include at least one element selected from the group consisting of Ti, Zr, Nb, W, P, Al, Mg, V, Ca, Sr, and Cr.)

In one example, in the lithium composite oxide prepared according to the preparation method embodiment, the ratio (Sₘ/S_{c}) of the measured specific surface area (Sₘ), based on the BET method, to the calculated specific surface area (S_{c}), based on the PSD analysis result, may be in a range of 2.59 to 3.05.

In one example, the heat treatment may be performed for 10 to 12 hours.

According to an embodiment of the present disclosure, a positive electrode active material in which pores are kept from being formed in a lithium composite oxide can be obtained by controlling the sintering conditions and composition of the positive electrode active material. Accordingly, the output characteristics of a positive electrode containing the positive electrode active material can be improved.

Effects of the present disclosure are not limited to the effects mentioned above. It can be understood that the effects of the present disclosure include all effects that can be deduced from the following description.

### BRIEF DESCRIPTION OF THE DRAWINGS

FIG. 1 schematically illustrates a structure of an all-solid-state battery containing a positive electrode active material according to an embodiment of the present disclosure.

FIG. 2 shows the evaluation results of charging and discharging half-cells according to examples and comparative examples, and according to some embodiments of the present disclosure.

### DETAILED DESCRIPTION OF ILLUSTRATIVE EMBODIMENTS

The above and other features and advantages of the present disclosure can be understood from the following example embodiments associated with the accompanying drawings. However, the present disclosure is not limited to the example embodiments described herein and may be embodied in other forms. The example embodiments described herein are provided so that the disclosure can be made thorough and complete and that the spirit of the present disclosure can be fully conveyed to those skilled in the art.

Throughout the drawings, like elements can be denoted by like reference numerals. In the accompanying drawings, the dimensions of the structures can be larger than actual sizes for clarity of the present disclosure. Terms used herein, “first”, “second”, etc., may be used to describe various components, but the components are not necessarily to be construed as being limited to such terms. These terms can be used merely for the purpose of distinguishing one component from another component. For example, without departing from scopes of the present disclosure, a first component may be referred to as a second component, and a second component may be also referred to as a first component. The singular expression can include the plural expression unless the context clearly indicates otherwise.

It can be further understood that the terms “comprises”, “includes”, or “has” used herein specify the presence of stated features, regions, integers, steps, operations, elements, and/or components, but do not preclude the presence or addition of one or more other features, regions, integers, steps, operations, elements, components, and/or combinations thereof. It can also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, numbers, values, and/or representations that express the amounts of components, reaction conditions, polymer compositions, and mixtures used herein can be taken as approximations including various uncertainties affecting measurement that inherently occur in obtaining these values, among others, and thus can be understood to be modified by the term “about”. Furthermore, when a numerical range is disclosed in this specification, the range can be continuous, and can include all values from the minimum value of said range to the maximum value thereof, unless otherwise indicated. Moreover, when such a range pertains to integer values, all integers including the minimum value to the maximum value can be included, unless otherwise indicated.

As used herein, when a range is described for a variable, the variable can be understood to include all values within the stated range, including the stated endpoints of the range. For example, a range of “5 to 10” includes values of 5, 6, 7, 8, 9, and 10, as well as any subranges such as 6 to 10, 7 to 10, 6 to 9, and 7 to 9. It will be understood to include any value between reasonable integers within the scope of the stated range, such as 5.5, 6.5, 7.5, 5.5 to 8.5, and 6.5 to 9. Additionally, for example, a range of “10% to 30%” includes values, such as 10%, 11%, 12%, and 13%, and all integers up to and including 30%, as well as any subranges such as 10% to 15%, 12% to 18%, and 20% to 30%. It can be understood to include any value between reasonable integers within the scope of the stated range, such as 10.5%, 15.5%, and 25.5%.

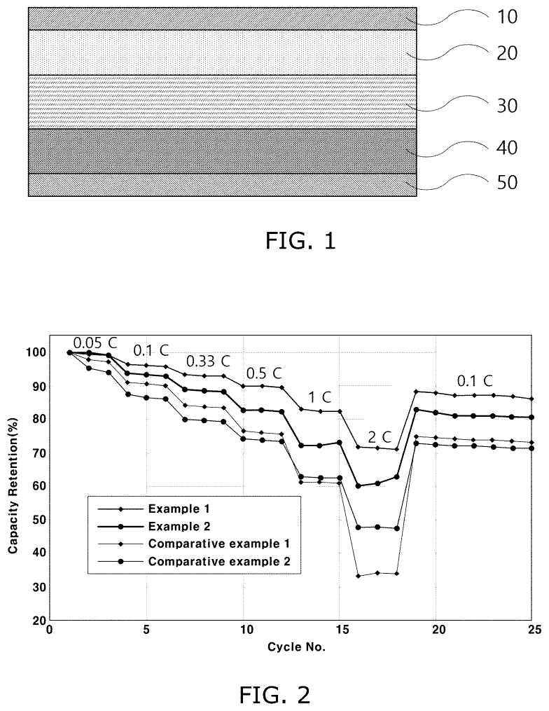

FIG. 1 illustrates an all-solid-state battery containing a positive electrode active material according to an embodiment of the present disclosure. The all-solid-state battery may be a stack of a positive electrode current collector 10, a positive electrode active material layer 20, a solid electrolyte layer 30, a negative electrode active material layer 40, and a negative electrode current collector 50.

The positive electrode current collector 10 may include an electrically conductive substrate having a plate-like form. The positive electrode current collector 10 may include an aluminum foil. In such example case, the thickness of the positive electrode current collector 10 is not particularly limited but may be, for example, in a range of 1 to 500 μm.

The positive electrode active material layer 20 may include the positive electrode active material. According to an embodiment of the present disclosure, the positive electrode active material may include a lithium composite oxide enabling intercalation or deintercalation of lithium, where in the lithium composite oxide, a ratio (Sₘ/S_{c}) of a measured specific surface area (Sₘ) based on a BET method to a calculated specific surface area (S_{c}) based on a particle size distribution (PSD) analysis result is in a range of 2.0 to 3.3.

In the present disclosure, the ratio (Sₘ/S_{c}) of the measured specific surface area (Sₘ), actually measured by the BET method, to the calculated specific surface area (S_{c}), based on the PSD analysis result, can be adjusted to fall within a set or predetermined numerical range to optimize the density of the positive electrode active material particles, thereby reducing the resistance in the all-solid-state battery. Accordingly, in an embodiment, an all-solid-state battery with improved output is obtainable.

The BET method herein may refer to a method of calculating the specific surface area, pore size, and distribution of the surface of a solid sample by absorbing and desorbing a specific gas (for example, nitrogen) onto the surface of the solid sample, using the formula developed by Brunauer, Emmett, and Teller. A known method of measuring the specific surface area of the positive electrode active material using the BET method in the art may be used.

The particle size distribution (PSD) herein may be measured with a laser diffraction-type particle size distribution analyzer. The particle size refers to the size of particles, which may mean, for example, the particle diameter.

In one example, the calculated specific surface area (S_{c}) of the positive electrode active material, calculated using the PSD analysis result, may satisfy the following equation:

$$Sc ( {m}^{2} / g ) = \frac{{\sum }_{d = 1}^{∞} ( {( ( {Size}_{d} ) \frac{1}{2} )}^{2} \times \% {Chan}_{d} ) \times 4}{{\sum }_{d = 1}^{∞} ( \frac{4}{3} {( ( {Size}_{d} ) \frac{1}{2} )}^{3} \times \% {Chan}_{d} ) \times 4.77}$$

(Here, d represents any positive electrode active material, Size_{d} is a particle diameter of positive electrode active material d, and % Chan_{d} is a ratio of the positive electrode active material having particle diameter Size_{d} to the entire positive electrode active material expressed in %).

The calculated specific surface area (S_{c}) of the positive electrode active material may refer to the average surface area per unit mass of the positive electrode active material. The average weight of a single positive electrode active material particle to calculate this value may be expressed as follows:

$${\sum }_{d = 1}^{∞} ( ( \frac{4}{3} {( ( {Size}_{d} ) \frac{1}{2} )}^{3} \times \% {Chan}_{d} \times π \times 100 ) \times 4.77 g / {cm}^{3} ) \times \frac{{cm}^{3}}{{µm}^{3}} \times \frac{1}{{( 10 , 000 )}^{3}}$$

(Here,

$$\frac{4}{3} {( ( {Size}_{d} ) \frac{1}{2} )}^{3}$$

is used to calculate the volume of positive electrode active material d having particle diameter Size_{d}, and “% Chan_{d}” and “100” are a distribution used to calculate the average mass of the positive electrode active material and a coefficient resulting from the process of expressing the distribution in %, respectively. Additionally, “4.77 g/cm³” may refer to the theoretical density of the positive electrode active material to calculate the mass from the measured volume of the positive electrode active material).

“Size_{d}” may refer to the particle diameter of positive electrode active material d observable when measuring a positive electrode active material containing two or more positive electrode active material particles with a particle size distribution analyzer. For example, “Size_{d}”, the particle diameter of the positive electrode active material, may be measured to be greater than 0 μm and smaller than or equal to 15 μm.

The average surface area of the single positive electrode active material particle may be expressed as follows:

$${\sum }_{d = 1}^{∞} ( {( ( {Size}_{d} ) \frac{1}{2} )}^{2} \times \% {Chan}_{d} \times 4 π \times 100 ) ) \times \frac{{m}^{2}}{{µm}^{2}} \times \frac{1}{{( 1 , 000 , 000 )}^{2}}$$

### (Here,

$${“ ( {Size}_{d} ) \frac{1}{2} )}^{2} ”$$

and “4π” are used to calculate the surface area of positive electrode active material d having particle diameter “Size_{d}”, and “% Chan_{d}” and “100” are a distribution used to calculate the average surface area of the positive electrode active material and a coefficient resulting from the process of expressing the distribution in %, respectively).

When dividing the average surface area of the single positive electrode active material particle by the average mass of the single positive electrode active material particle and then organizing the coefficient and unit, the calculated specific surface area (S_{c}) of the positive electrode active material, calculated using the particle size distribution analysis result, is derivable.

In the case where a number of pores are present inside the lithium composite oxide or positive electrode active material, the weight relative to the same volume decreases, and the surface area increases, thereby increasing the calculated specific surface area (S_{c}).

In the lithium composite oxide, the ratio (Sₘ/S_{c}) of the measured specific surface area (Sₘ), based on the BET method, to the calculated specific surface area (S_{c}), derived using the PSD analysis result and the above equation, that falls within a range of 2.0 to 3.3 can imply that the specific surface area of the positive electrode active material calculated using the particle size and particle size distribution are similar with the specific surface area of the positive electrode active material actually measured using the BET method, corresponding to pores being kept from being formed in the positive electrode active material, and the true density can be high. Accordingly, the output of the positive electrode or all-solid-state battery containing the positive electrode active material may increase.

In the lithium complex oxide, the ratio (Sₘ/S_{c}) of the measured specific surface area (Sₘ), based on the BET method, to the calculated surface area (S_{c}), derived using the PSD analysis result and the above equation, can be in a range of 2.59 to 3.05.

In the lithium composite oxide, when the ratio (Sₘ/S_{c}) of the measured specific surface area (Sₘ), based on the BET method, to the calculated specific surface area (S_{c}), derived using the PSD analysis result and the above equation, can exceed 3.3, a number of pores may be formed in the positive electrode active material, leading to a decrease in true density and deterioration in output characteristics.

In one example, the lithium composite oxide may be represented by Formula 1.

LiNi_{1-x-y}CoₓMn_{y}M¹_{z}O₂ [Formula 1]

Here, x, y, and z may satisfy 0<x<0.4, 0<y<0.4, 0≤z<0.4, and 0<x+y+z≤0.4. Additionally, M¹ may include at least one element selected from the group consisting of Ti, Zr, Nb, W, P, Al, Mg, V, Ca, Sr, and Cr.

The positive electrode active material may further include a coating layer coating the surface thereof. The coating layer may block the positive electrode active material and the solid electrolyte from being in physical contact, thereby preventing side reactions from occurring between the two components. The material of the coating layer is not particularly limited but may include LiNbO₃, Li₂CO₃, and Li₃BO₃. Additionally, the thickness of the coating layer is not particularly limited but may be in a range of 5 to 500 nm or 10 to 100 nm.

In one example, the positive electrode active material layer 20 may further include a solid electrolyte, a binder, a conductive additive, and the like. The solid electrolyte may include an oxide-based solid electrolyte, a sulfide-based solid electrolyte, and the like. In such example case, a sulfide-based solid electrolyte having high ionic conductivity can be used.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one among Ge, Zn, and Ga), Li₂S—GeS₂, Li₂S—SiS₂—Li₃PO₄, Li₂S—SiS₂-LiₓMO_{y} (where x and y are each independently a positive integer, and M is one among P, Si, Ge, B, Al, Ga, and In), Li₁₀GeP₂S₁₂, and the like. The sulfide-based solid electrolyte can be represented by Formula 2.

Li_{3-2X}M²_{X}In_{1-Y}M³_{Y}L_{6-Z}L′_{Z} [Formula 2]

Here, M² and M³ are metallic elements and may each independently be, for example, one selected from the group consisting of S, Sn, Mg, Ba, B, Al, Ga, In, Si, Ge, Pb, N, P, As, Sb, Bi, Ti, V, Cr, Mn, Fe, Co, Ni, Cu, Y, Zr, Nb, Mo, Tc, Ru, Rh, Pd, Ag, Hf, Ta, W, La, and a combination thereof. L and L′ are halogen elements and may each independently be, for example, one selected from the group consisting of Cl, Br, I, and a combination thereof.

Additionally, X, Y, and Z may satisfy 0≤X<1.5, 0≤Y<1, and 0≤Z≤6, respectively. At least one among M² and M³ can contain sulfur(S).

Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), and the like.

Examples of the binder may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC), and the like.

Examples of the conductive additive may include carbon black, conducting graphite, ethylene black, vapor-grown carbon fibers, graphene, and the like.

The positive electrode active material layer 20 may include the positive electrode active material and the solid electrolyte in a mass ratio in a range of 6:4 to 9:1. When the mass ratio of the positive electrode active material is low, the capacity of the all-solid-state battery may decrease. On the contrary, when the mass ratio of the positive electrode active material is high, the amount of the solid electrolyte may be reduced, so the lithium-ion conductivity in the positive electrode active material layer 20 may be reduced.

The solid electrolyte layer 30 is positioned between the positive electrode active material layer 20 and the negative electrode active material layer 40 and may include a solid electrolyte having lithium-ion conductivity.

The solid electrolyte may include an oxide-based solid electrolyte, a sulfide-based solid electrolyte, and the like. In such example case, a sulfide-based solid electrolyte having high ionic conductivity can be used.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one among Ge, Zn, and Ga), Li₂S—GeS₂, Li₂S—SiS₂—Li₃PO₄, Li₂S—SiS₂-LiₓMO_{y} (where x and y are each independently a positive integer, and M is one among P, Si, Ge, B, Al, Ga, and In), Li₁₀GeP₂S₁₂, and the like.

Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), and the like.

The negative electrode active material layer 40 may include a negative electrode active material, a binder, and the like.

The negative electrode active material may include a carbon-based negative electrode active material, a non-carbon-based negative electrode active material, and the like.

The carbon-based negative electrode active material may include graphite, such as mesocarbon microbeads (MCMB) and highly oriented graphite (HOPG), or amorphous carbon, such as hard carbon and soft carbon. The non-carbon-based negative electrode active material may include a metal including at least one selected from the group consisting of In, Al, Si, Sn, and a combination thereof, a metal oxide, and the like.

Examples of the binder may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC), and the like.

The negative electrode current collector 50 may be an electrically conductive substrate having a plate-like form. Specifically, the negative electrode current collector 50 may have a sheet, thin film, or foil form. The negative electrode current collector 50 may include a material that does not react with lithium. Specifically, the negative electrode current collector 50 may include at least one selected from the group consisting of Ni, Cu, stainless steel (SUS), and a combination thereof.

The thickness of the negative electrode current collector 50 is not particularly limited but may be, for example, in a range of 1 to 500 μm.

Hereinafter, an example method embodiment of preparing the positive electrode active material will be described.

### Method Embodiment of Preparing Positive Electrode Active Material

An embodiment of the present disclosure can provide a method of preparing a positive electrode active material for an all-solid-state battery, which includes: synthesizing a hydroxide precursor containing a transition metal; and obtaining a lithium composite oxide by mixing a lithium precursor with the hydroxide precursor and then subjecting the resulting mixture to heat treatment, in which the heat treatment is performed at a temperature of higher than 700° C. and lower than 800° C.

The hydroxide precursor containing the transition metal may be synthesized using a co-precipitation method. Specifically, after adding water to a reactor, salts of each transition metal that match the composition of a desired positive electrode active material can be mixed. While maintaining the reactor at a temperature in a range of 50° C. to 80° C., inert gas can be introduced into the reactor to keep the prepared hydroxide precursor from being oxidized. After the completion of synthesis and stirring, the hydroxide precursor can be obtainable through washing and dehydration using filter press (F/P) equipment.

Alternatively, salts of each transition metal that match the composition of a desired positive electrode active material can be dissolved in water to prepare an aqueous solution. Then, the aqueous solution can be introduced into a sodium hydroxide solution while being stirred. When stirring the resulting product, the hydroxide-form precursor containing the transition metal can be precipitable.

After synthesizing the hydroxide precursor through such a process, the lithium precursor or lithium raw material may be added. The lithium precursor is not particularly limited. For example, lithium hydroxide (LiOH) and the like may be used.

The lithium precursor and the hydroxide precursor may be weighed and mixed according to the composition of the desired positive electrode active material, and then the heat treatment may be performed. In one example, the heat treatment may be performed at a temperature of higher than 700° C. and lower than 800° C. for 10 to 12 hours. When the heat treatment is performed at a temperature of 700° C. or lower, the low sintering temperature of the positive electrode active material may deteriorate the quality thereof. On the contrary, when the heat treatment is performed at a temperature of 800° C. or higher, a number of pores may be formed in the positive electrode active material, leading to a decrease in true density and deterioration in output characteristics.

Additionally, when the heat treatment is performed for 10 to 12 hours, a sufficient amount of heat supplied in the process of preparing the positive electrode active material may keep pores from being formed in the positive electrode active material, and the true density may increase, thereby improving output characteristics.

In one example, in the lithium composite oxide prepared according to an embodiment of the preparation method, a ratio (Sₘ/S_{c}) of a measured specific surface area (Sₘ) based on a BET method to a calculated specific surface area (S_{c}) based on a particle size distribution (PSD) analysis result may be in a range of 2.0 to 3.3.

In one example, the calculated specific surface area (S_{c}) may satisfy the following equation:

$$Sc ( {m}^{2} / g ) = \frac{{\sum }_{d = 1}^{∞} ( {( ( {Size}_{d} ) \frac{1}{2} )}^{2} \times \% {Chan}_{d} ) \times 4}{{\sum }_{d = 1}^{∞} ( \frac{4}{3} {( ( {Size}_{d} ) \frac{1}{2} )}^{3} \times \% {Chan}_{d} ) \times 4.77}$$

(Here, d represents any positive electrode active material, Size_{d} is a particle diameter of positive electrode active material d, and % Chan_{d} is a ratio of the positive electrode active material having particle diameter Size_{d} to the entire positive electrode active material expressed in %).

In one example, the lithium composite oxide, prepared according to the preparation method embodiment, may be represented by Formula 1.

LiNi_{1-x-y}CoₓMn_{y}M¹_{z}O₂ [Formula 1]

Here, x, y, and z may satisfy 0<x<0.4, 0<y<0.4, 0≤z<0.4, and 0<x+y+z≤0.4. Additionally, M¹ may include at least one element selected from the group consisting of Ti, Zr, Nb, W, P, Al, Mg, V, Ca, Sr, and Cr.

In one example, in the lithium composite oxide, prepared according to the preparation method embodiment, the ratio (Sₘ/S_{c}) of the measured specific surface area (Sₘ), based on the BET method, to the calculated specific surface area (S_{c}), based on the PSD analysis result, may be in a range of 2.59 to 3.05.

The lithium composite oxide and the positive electrode active material containing the same, prepared according to the preparation method embodiment, can be practically the same as those described above, so redundant detailed descriptions will be omitted.

Hereinafter, the present disclosure will be described in detail with reference to the following examples and comparative examples. However, technical ideas of the present disclosure are not necessarily limited or restricted thereto.

### Preparation of Positive Electrode Active Material

### (1) Preparation Example 1

A spherical Ni_{0.80}Co_{0.10}Mn_{0.10}(OH)₂ hydroxide precursor was synthesized by a co-precipitation method. Specifically, in a 90-L reactor, 25 wt % of NaOH and 30 wt % of NH₄OH were introduced into an aqueous 1.5 M sulfuric acid solution of a transition metal composite where nickel sulfate, cobalt sulfate, and manganese sulfate were mixed in a molar ratio of 80:1:1. The pH in the reactor was maintained at 11.5 while maintaining the temperature of the reactor at 60° C. An inert gas, N₂, was added to the reactor to keep the prepared precursor from being oxidized. After the completion of synthesis and stirring, the Ni_{0.8}Co_{0.1}Mn_{0.1}(OH)₂ hydroxide precursor was obtained through washing and dehydration using filter press (F/P) equipment.

Next, LiOH, a lithium precursor, was added to the synthesized hydroxide precursor, and then the resulting product was sintered to prepare a lithium composite oxide. Specifically, after mixing LiOH with the hydroxide precursor, the resulting mixture was subjected to heat temperature for 10 hours by maintaining an O₂ atmosphere in a sintering furnace while raising the temperature to 780° C. at a speed of 1° C. per minute and then naturally cooled to obtain the lithium composite oxide.

### (2) Preparation Example 2

A positive electrode active material was prepared in the same manner as in Preparation Example 1, except that in the process of preparing the lithium composite oxide, after mixing LiOH with the hydroxide precursor, the resulting mixture was subjected to heat temperature for 11 hours by maintaining the O₂ atmosphere in the sintering furnace while raising the temperature to 750° C. at a speed of 1° C. per minute and then naturally cooled.

### (3) Comparative Preparation Example 1

A positive electrode active material was prepared in the same manner as in Preparation Example 1, except that in the process of preparing the lithium composite oxide, after mixing LiOH with the hydroxide precursor, the resulting mixture was subjected to heat temperature for 12 hours by maintaining the O₂ atmosphere in the sintering furnace while raising the temperature to 700° C. at a speed of 1° C. per minute and then naturally cooled.

### (4) Comparative Preparation Example 2

A positive electrode active material was prepared in the same manner as in Preparation Example 1, except that in the process of preparing the lithium composite oxide, after mixing LiOH with the hydroxide precursor, the resulting mixture was subjected to heat temperature for 10 hours by maintaining the O₂ atmosphere in the sintering furnace while raising the temperature to 800° C. at a speed of 1° C. per minute and then naturally cooled.

### Manufacturing of Half-Cell

### (1) Example 1

A solid electrolyte layer 30 was formed by compressing a sulfide-based solid electrolyte doped with indium (In) at a pressure of about 10 MPa for 10 seconds.

A mixture including the positive electrode active material according to Preparation Example 1, the sulfide-based solid electrolyte, and a conductive additive in a mass ratio of 69:29:2 was prepared. The mixture was applied to a first surface of the solid electrolyte layer 30 at a loading amount of about 13 mg/cm². A lithium-indium thin film was attached to a second surface of the solid electrolyte layer 30 as a negative electrode, which is a counter electrode. A half-cell was obtained by compressing such an obtained stack at a pressure of about 32 MPa for 5 minutes.

### (2) Example 2

A half-cell was manufactured through the same process as in Example 1, except for using the positive electrode active material according to Preparation Example 2.

### (3) Comparative Example 1

A half-cell was manufactured through the same process as in Example 1, except for using the positive electrode active material according to Comparative Preparation Example 1.

### (4) Comparative Example 2

A half-cell was manufactured through the same process as in Example 1, except for using the positive electrode active material according to Comparative Preparation Example 2.

### Experimental Example 1—Particle Size Distribution (PSD) Analysis and Specific Surface Area (S_{c}) Calculation

The particle size distributions of the positive electrode active materials, according to Preparation Examples 1 and 2 and Comparative Preparation Examples 1 and 2, were measured with a particle size analyzer. The results thereof are shown in Table 1 below. In Table 1 below, only the beginning of the section where the particle diameter ratio of the positive electrode active material is 0% is shown.

TABLE 1

| | | | | Comparative | | Comparative | |
|---|---|---|---|---|---|---|---|
| Preparation | | Preparation | | Preparation | | Preparation | |
| Example 1 | | Example 2 | | Example 1 | | Example 2 | |
| Particle | | Particle | | Particle | | Particle | |
| diameter | % Chan | diameter | % Chan | diameter | % Chan | diameter | % Chan |
| d (μm) | (ratio) | d (μm) | (ratio) | d (μm) | (ratio) | d (μm) | (ratio) |
| 12 | 0 | 15.56 | 0.24 | 22 | 0.2 | 37 | 0.08 |
| 11 | 0.17 | 14.27 | 0.38 | 20.17 | 0.38 | 33.93 | 0.16 |
| 10.09 | 0.4 | 13.08 | 0.48 | 18.5 | 0.58 | 31.11 | 0.25 |
| 9.25 | 0.84 | 12 | 0.77 | 16.96 | 0.95 | 28.53 | 0.43 |
| 8.48 | 1.21 | 11 | 1.3 | 15.56 | 1.54 | 26.16 | 0.74 |
| 7.78 | 1.71 | 10.09 | 2.25 | 14.27 | 2.04 | 23.99 | 0.99 |
| 7.13 | 2.76 | 9.25 | 3.8 | 13.08 | 2.38 | 22 | 1.22 |
| 6.54 | 4.12 | 8.48 | 5.11 | 12 | 3.39 | 20.17 | 1.67 |
| 6 | 11.06 | 7.78 | 6.11 | 11 | 5.2 | 18.5 | 2.37 |
| 5.5 | 29.23 | 7.13 | 7.96 | 10.09 | 6.12 | 16.96 | 3.52 |
| 5.04 | 29.78 | 6.54 | 10.51 | 9.25 | 6.16 | 15.56 | 5.31 |
| 4.63 | 12.86 | 6 | 13.34 | 8.48 | 6.17 | 14.27 | 6.49 |
| 4.24 | 4.96 | 5.5 | 16.97 | 7.78 | 6.06 | 13.08 | 6.81 |
| 3.89 | 0.86 | 5.04 | 15.17 | 7.13 | 6.38 | 12 | 8.79 |
| 3.57 | 0.04 | 4.63 | 8.06 | 6.54 | 7.17 | | |
| 3.27 | 0 | 4.24 | 4.11 | 6 | 7.77 | | |
| 2.999 | 0 | 3.89 | 2.06 | 5.5 | 8.16 | | |
| | | 3.57 | 0.87 | 5.04 | 8.21 | | |
| | | 3.27 | 0.37 | 4.63 | 8.05 | | |
| | | 2.999 | 0.14 | 4.24 | 6.41 | | |
| | | | | 3.89 | 3.41 | | |
| | | | | 3.57 | 1.7 | | |
| | | | | 3.27 | 0.82 | | |
| | | | | 2.999 | 0.37 | | |
| | | | | 2.75 | 0.24 | | |
| | | | | 2.522 | 0.14 | | |

The calculated specific surface area was derived by substituting the values listed in Table 1 above into the following formula and the results thereof are shown in Table 2:

$$Sc ( {m}^{2} / g ) = \frac{{\sum }_{d = 1}^{∞} ( {( ( {Size}_{d} ) \frac{1}{2} )}^{2} \times \% {Chan}_{d} ) \times 4}{{\sum }_{d = 1}^{∞} ( \frac{4}{3} {( ( {Size}_{d} ) \frac{1}{2} )}^{3} \times \% {Chan}_{d} ) \times 4.77}$$

(Here, d represents any positive electrode active material, Size_{d} is a particle diameter of positive electrode active material d, and % Chan_{d} is a ratio of the positive electrode active material having particle diameter Size_{d} to the entire positive electrode active material expressed in %).

TABLE 2

| | | | Comparative | Comparative |
|---|---|---|---|---|
| | Preparation | Preparation | Preparation | Preparation |
| | Example 1 | Example 2 | Example 1 | Example 2 |
| S_{c} (m²/g) | 0.2164 | 0.1681 | 0.1191 | 0.0827 |

### Experimental Example 2—Ratio (Sₘ/S_{c}) of BET Specific Surface Area to Specific Surface Area

The BET specific surface areas (Sₘ) of the positive electrode active materials, according to Preparation Examples 1 and 2 and Comparative Preparation Examples 1 and 2, were measured with a BET specific surface area analyzer. Next, the measured specific surface area (Sₘ) was divided by the calculated specific surface area (S_{c}) obtained through calculation in Experimental Example 1. The results thereof are shown in Table 3 below.

TABLE 3

| Classification | Sintering conditions | S_{c} | Sₘ | Sₘ/S_{c} |
|---|---|---|---|---|
| Preparation Example 1 | 780° C./10 hours | 0.2164 | 0.5622 | 2.59 |
| Preparation Example 2 | 750° C./11 hours | 0.1681 | 0.5122 | 3.05 |
| Comparative | 700° C./12 hours | 0.1191 | 0.4775 | 4.01 |
| Preparation Example 1 | | | | |
| Comparative | 800° C./10 hours | 0.0827 | 0.4726 | 5.71 |
| Preparation Example 2 | | | | |

From Table 3, it was confirmed that the Sₘ/S_{c} values in the positive electrode active materials, according to Preparation Examples 1 and 2, were exhibited within a range of 2.0 to 3.3.

### Experimental Example 3-Charge and Discharge Evaluation

The half-cells, according to Examples 1 and 2 and Comparative Examples 1 and 2, were charged with a constant current (CC) of 0.188 C at a temperature of 30° C. to a voltage level of −3.68 V and then discharged with a constant current of 0.1 C to a voltage level of 1.88V. Next, the half-cells were charged and discharged at 0.05 C, 0.1 C 0.33 C, 0.5 C, 1 C, and 2 C while maintaining the same voltage level. The results thereof are shown in FIG. 2.

From FIG. 2, it was confirmed that Examples 1 and 2, in which the parameter values (Sₘ/S_{c}) were small, exhibited better output characteristics than Comparative Examples 1 and 2. In particular, it was confirmed that the output characteristics deteriorated in the range where the parameter value (Sₘ/S_{c}) exceeded 3.3. Specifically, the 0.5-C retention (%) (0.5-C capacity/0.1-C capacity) of each positive electrode active material, identified from FIG. 2, was confirmed as follows: 90% in Example 1, 82.6% in Example 2, 76.4% in Comparative Example 1, and 74.3% in Comparative Example 2. This is because a number of pores may be formed in the positive electrode active materials, according to Comparative Examples 1 and 2, leading to a decrease in particle density compared to that of Examples 1 and 2, and such formed pores may increase internal resistance, leading to a decrease in output.

Although example embodiments of the present disclosure have been disclosed for illustrative purposes, those skilled in the art can appreciate that diverse variations and modifications are possible through addition, alteration, deletion, etc. of elements, without departing from the spirit and scopes of the present disclosure.

What is claimed is:

1. A positive electrode active material for an all-solid-state battery, the positive electrode active material comprising a lithium composite oxide enabling intercalation or deintercalation of lithium, wherein in the lithium composite oxide, a ratio (Sₘ/S_{c}) of a measured specific surface area (Sₘ) based on a Brunauer-Emmett-Teller (BET) method to a calculated specific surface area (S_{c}) based on a particle size distribution (PSD) analysis result is in a first range of 2.0 to 3.3.

2. The positive electrode active material of claim 1, wherein the calculated specific surface area (S_{c}) satisfies
$$Sc ( \frac{{m}^{2}}{g} ) = \frac{{{\sum }_{d = 1}^{∞} ( ( 〚 ( {Size}_{d} ) \frac{1}{2} ) 〛}^{2} \times \% {Chan}_{d} ) \times 4}{{\sum }_{d = 1}^{∞} ( {\frac{4}{3 ( ( {Size}_{d} ) \frac{1}{2} )}}^{3} \times \% {Chan}_{d} ) \times 4.77}$$
wherein d represents the positive electrode active material, wherein Size_{d} is a particle diameter of the positive electrode active material, and wherein % Chan_{d} is a ratio of the positive electrode active material having the particle diameter Size_{d} to an entire positive electrode active material expressed in percentage.

3. The positive electrode active material of claim 1, wherein the lithium composite oxide is represented by LiNi_{1-x-y}CoₓMn_{y}M¹_{z}O₂, wherein x, y, and z satisfy 0<x<0.4, 0<y<0.4, 0≤z<0.4, and 0<x+y+z≤0.4, and wherein M¹ comprises at least one element selected from the group consisting of Ti, Zr, Nb, W, P, Al, Mg, V, Ca, Sr, and Cr.

4. The positive electrode active material of claim 1, wherein the ratio (Sₘ/S_{c}) is in a second range of 2.59 to 3.05.

5. A positive electrode active material layer comprising:
a positive electrode active material comprising a lithium composite oxide enabling intercalation or deintercalation of lithium, wherein in the lithium composite oxide, a ratio (Sₘ/S_{c}) of a measured specific surface area (Sₘ) based on a Brunauer-Emmett-Teller (BET) method to a calculated specific surface area (S_{c}) based on a particle size distribution (PSD) analysis result is in a first range of 2.0 to 3.3; and
a sulfide-based solid electrolyte.

6. The layer of claim 5, wherein the calculated specific surface area (S_{c}) satisfies
$$Sc ( \frac{{m}^{2}}{g} ) = \frac{{{\sum }_{d = 1}^{∞} ( ( 〚 ( {Size}_{d} ) \frac{1}{2} ) 〛}^{2} \times \% {Chan}_{d} ) \times 4}{{\sum }_{d = 1}^{∞} ( {\frac{4}{3 ( ( {Size}_{d} ) \frac{1}{2} )}}^{3} \times \% {Chan}_{d} ) \times 4.77}$$
wherein d represents the positive electrode active material, wherein Size_{d} is a particle diameter of the positive electrode active material, and wherein % Chan_{d} is a ratio of the positive electrode active material having the particle diameter Size_{d} to an entire positive electrode active material expressed in percentage.

7. The layer of claim 5, wherein the lithium composite oxide is represented by
LiNi_{1-x-y}CoₓMn_{y}M¹_{z}O₂,
wherein x, y, and z satisfy 0<x<0.4, 0<y<0.4, 0≤z<0.4, and 0<x+y+z≤0.4, and
wherein M¹ comprises at least one element selected from the group consisting of Ti, Zr, Nb, W, P, Al, Mg, V, Ca, Sr, and Cr.

8. The layer of claim 5, wherein the ratio (Sₘ/S_{c}) is in a second range of 2.59 to 3.05.

9. The layer of claim 5, wherein the sulfide-based solid electrolyte is represented by
Li_{3-2X}M²_{X}In_{1-Y}M³_{Y}L_{6-Z}L′_{Z},
wherein M² and M³ are each independently one selected from the group consisting of S, Sn, Mg, Ba, B, Al, Ga, In, Si, Ge, Pb, N, P, As, Sb, Bi, Ti, V, Cr, Mn, Fe, Co, Ni, Cu, Y, Zr, Nb, Mo, Tc, Ru, Rh, Pd, Ag, Hf, Ta, W, La, and any combination thereof,
wherein L and L′ are each independently one selected from the group consisting of Cl, Br, I, and any combination thereof, and
wherein X, Y, and Z satisfy 0≤X<1.5, 0≤Y<1, and 0≤Z≤6, respectively.

10. A method of preparing a positive electrode active material for an all-solid-state battery, the method comprising:
synthesizing a hydroxide precursor containing a transition metal;
obtaining a lithium composite oxide by mixing a lithium precursor with the hydroxide precursor; and
after the obtaining the lithium composite oxide, subjecting a resulting mixture to a heat treatment, wherein the heat treatment is performed at a temperature in a temperature range of higher than 700° C. and lower than 800° C.

11. The method of claim 10, wherein in the lithium composite oxide, a ratio (Sₘ/S_{c}) of a measured specific surface area (Sₘ) based on a Brunauer-Emmett-Teller (BET) method to a calculated specific surface area (S_{c}) based on a particle size distribution (PSD) analysis result is in a first range of 2.0 to 3.3.

12. The method of claim 11, wherein the calculated specific surface area (S_{c}) satisfies
$$Sc ( \frac{{m}^{2}}{g} ) = \frac{{{\sum }_{d = 1}^{∞} ( ( 〚 ( {Size}_{d} ) \frac{1}{2} ) 〛}^{2} \times \% {Chan}_{d} ) \times 4}{{\sum }_{d = 1}^{∞} ( {\frac{4}{3 ( ( {Size}_{d} ) \frac{1}{2} )}}^{3} \times \% {Chan}_{d} ) \times 4.77}$$
wherein d represents the positive electrode active material, wherein Size_{d} is a particle diameter of the positive electrode active material, and wherein % Chan_{d} is a ratio of the positive electrode active material having the particle diameter Size_{d} to an entire positive electrode active material expressed in percentage.

13. The method of claim 10, wherein the lithium composite oxide is represented by
LiNi_{1-x-y}CoₓMn_{y}M¹_{z}O₂,
wherein x, y, and z satisfy 0<x<0.4, 0<y<0.4, 0≤z<0.4, and 0<x+y+z≤0.4, and
wherein M¹ comprises at least one element selected from the group consisting of Ti, Zr, Nb, W, P, Al, Mg, V, Ca, Sr, and Cr.

14. The method of claim 11, wherein the ratio (Sₘ/S_{c}) is in a second range of 2.59 to 3.05.

15. The method of claim 10, wherein the heat treatment is performed for 10 to 12 hours.
